(19) United States
(12) Patent Application Publication
(10) Pub. No.: US 2003/0038973 A1
(43) Pub. Date: Feb. 27, 2003

(54) Gray scale scanning method and system

(76) Inventor: Chen-Ho Lee, Hsinchu (TW)

Correspondence Address: J.C. PATENTS, INC., SUITE 250, 4 VENTURE, IRVINE, CA, 92618, US

(21) Appl. No.: 09/940,358

(22) Filed: Aug. 27, 2001

(51) Int. Cl. H04N 1/40

(52) U.S. Cl. 358/3.01; 358/461

(57) ABSTRACT

A gray scale scanning method and system. Three groups of gamma table data are downloaded into a color scanner. Each group of gamma tables includes a plurality of index addresses and each index address corresponds to a storage space. During downloading, the gray scale pixels are scanned to obtain corresponding digital data. The digital data includes the brightness value of the three primary colors belonging to each gray scale pixel. The brightness value of the three primary colors and corresponding index address of the three groups of gamma tables are compared to obtain an index address identical to the three primary color brightness values of the gray scale pixels. According to the three index addresses, color space conversion values belonging to the gray scale pixels are obtained. The values are transferred to the host for conducting two add operations so that the gray scale brightness values of the gray scale pixels are found.

### BACKGROUND OF THE INVENTION

1. Field of Invention

The present invention relates to a gray scale scanning method and system. More particularly, the present invention relates to a method and system for scanning a gray scale image using a color scanner.

2. Description of Related Art

In general, scanners can be classified as a black-and-white, a gray scale or a color scanner. Scanners are categorized in this way to distinguish the type of image color obtained after scanning. Obviously, a black-and-white scanner can be used to scan a color picture. However, the image obtained from the scanning is black-and-white. Similarly, if a gray scale scanner is used to scan a color picture, a gray scale image having a coloring effect much better than a simple black-and-white scanner is produced.

Aside from the aforementioned applications, a user may use a color scanner to scan a black-and-white or a gray scale picture. Obviously, the color scanner needs to perform less image-processing work when a pure black-and-white picture is scanned because a black-and-white image only has two possible colors. However, in a gray scale image scanning, different levels of gray colors (depending on the brightness value) are possible between black and white. Hence, a color scanner processing a gray scale image must perform a color-to-gray scale conversion. To implement such gray scale conversion, the color scanner need to design special hardware thereby increasing production cost as well as processing time.

There are conventional designs that simply incorporate additional hardware inside a color scanner so that scanned color image may be converted into gray scale data. After the gray scale data is converted, the data is transferred to a host terminal. This type of hardware circuit for scanning gray scale images has the advantages of a rapid response and high quality results. The disadvantage is a higher production cost.

Another implementation of gray scale conversion is through software at the host terminal. The color image data captured by a color scanner is converted into gray scale data. One major advantage for this type of implementation is the production of quality images without the need to pay for any additional hardware. However, for a color scanner, the host terminal needs to process the gray scale image data three times (because brightness level of the three primary colors R, G, B for each gray scale pixel must be transmitted). Furthermore, brightness level data for the three primary colors R, G, B must undergo complicated computations to convert the data into gray scale data. Hence, the conversion efficiency is low.

There is, however, another conventional color-to-gray scale conversion method. The method selects only one of the three primary colors R/G/B to serve as a channel for capturing scan images. The advantage is rapidity without incurring additional production cost and the disadvantage is poor resulting image quality.

In the computational techniques for converting color-to-gray scale data, the following formula is often used:

Y=C_{R}^{*}R+C_{G}^{*}G+C_{B}^{*}B

or

Y=C_{R}^{*}R′+C_{G}^{*}G′+C_{B}^{*}B′,

where Y is the gray scale brightness level of gray scale pixel; C_{R,} C_{G} and C_{B} are primary color coefficient: C_{R}=0.299, C_{G}=0.587, C_{B}=0.114; R, G, B are the brightness levels of the respective color image data; and R′, G′, B′ are the brightness levels of the respective color image data after a gamma correction.

The aforesaid methods use pure hardware or pure software or one of the three R/G/B colors as a channel for implementing color-to-gray scale conversion computation. However, each method has its own types of drawbacks with regards to speed, quality and cost. Hence, designing a color scanning having all the aforementioned advantages but avoiding all the disadvantages so that a high-quality image is obtained rapidly is a major direction of development.

### SUMMARY OF THE INVENTION

Accordingly, one object of the present invention is to provide a method for scanning a gray scale image so that high quality images are produced rapidly without incurring additional hardware cost.

To achieve these and other advantages and in accordance with the purpose of the invention, as embodied and broadly described herein, the invention provides a method for scanning a gray scale image. The method includes downloading three groups of gamma tables into a color scanner. Each group of gamma table includes a plurality of index addresses and each index address corresponds to a storage space. Furthermore, each storage space contains color a space conversion value related to a color-to-gray scale conversion.

During downloading, the gray scale pixels are scanned to obtain corresponding digital data. The digital data includes the brightness value of the three primary colors belonging to each gray scale pixel. Thereafter, the brightness value of the three primary colors and corresponding index address of the three groups of gamma tables are compared to obtain an index address identical to the three primary color brightness values of the gray scale pixels.

According to the three index addresses, color space conversion values belonging to the gray scale pixels are obtained. The values are transferred to the host for conducting two add operations so that the gray scale brightness values of the gray scale pixels are found.

This invention also provides a gray scale image scanning system that facilitates the scanning of a gray scale image by color scanner and transfers the brightness values of the gray scale image to a color scanner linked host. The gray scale image includes a plurality of gray scale pixels. Furthermore, the system uses devices and software that are frequently found inside most color scanners and hosts.

The gray scale image-scanning system further includes a memory, a buffer region, a control device and adder units. The memory is installed inside the color scanner for holding the three groups of gamma tables downloaded from the host. Each group of gamma table includes a plurality of index addresses and each index address corresponds to a storage space. In addition, each storage space holds a color space conversion value related to color-to-gray scale conversion.

The buffer region is also installed inside the color scanner and coupled to the memory for holding at least one digital data after a scanned gray scale pixel is converted into digital data. The digital data includes three digitized primary color brightness values with each digitized primary color brightness value corresponding to a group gamma table.

The control device is also installed within the color scanner and coupled with the memory and the buffer region for comparing the three digitized primary color brightness values of the gray scale pixel with corresponding index addresses of the three groups of gamma tables. The color space conversion value of each gray scale pixel is obtained from the storage space that corresponds to the index address. Finally, the color space conversion values corresponding to the three digitized primary color brightness values are transferred to the host.

The adder units within the host executes an addition operation using the three color space conversion values related to the gray scale pixels to obtain the gray scale brightness values of the gray scale pixels.

In this invention, original hardware devices installed within the color scanner are used to execute the multiplication portion of the color-to-gray scale computation and obtain three color space conversion values. In addition, the three color space conversion values are added together in two addition operations carried out inside the host conducted using inherent adding function provided by the host. Consequently, the color scanner is able to scan a gray scale picture and produce high-quality images rapidly without incurring any additional hardware production cost.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a flow chart showing a method of scanning gray scale images using a color scanner according to this invention;

FIG. 2 is a block diagram showing a color scanning system for scanning a gray scale image according to this invention; and

FIG. 3 is a schematic diagram showing the memory structure within a color scanner according to this invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

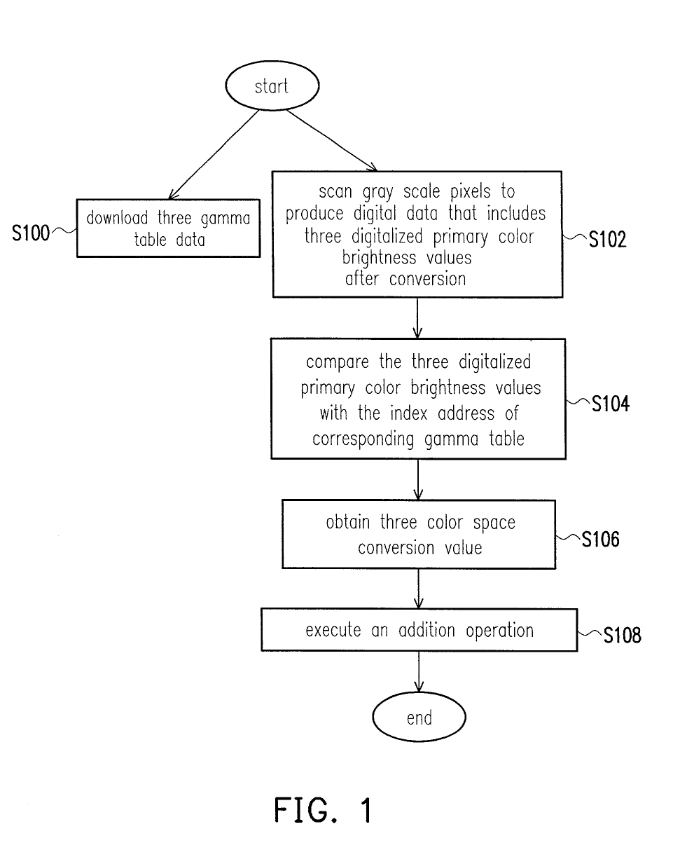

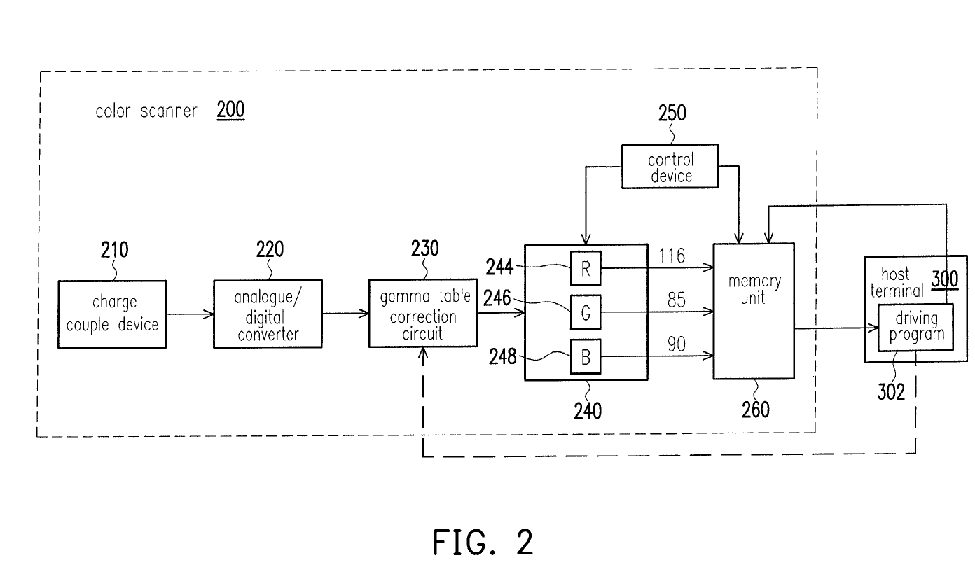

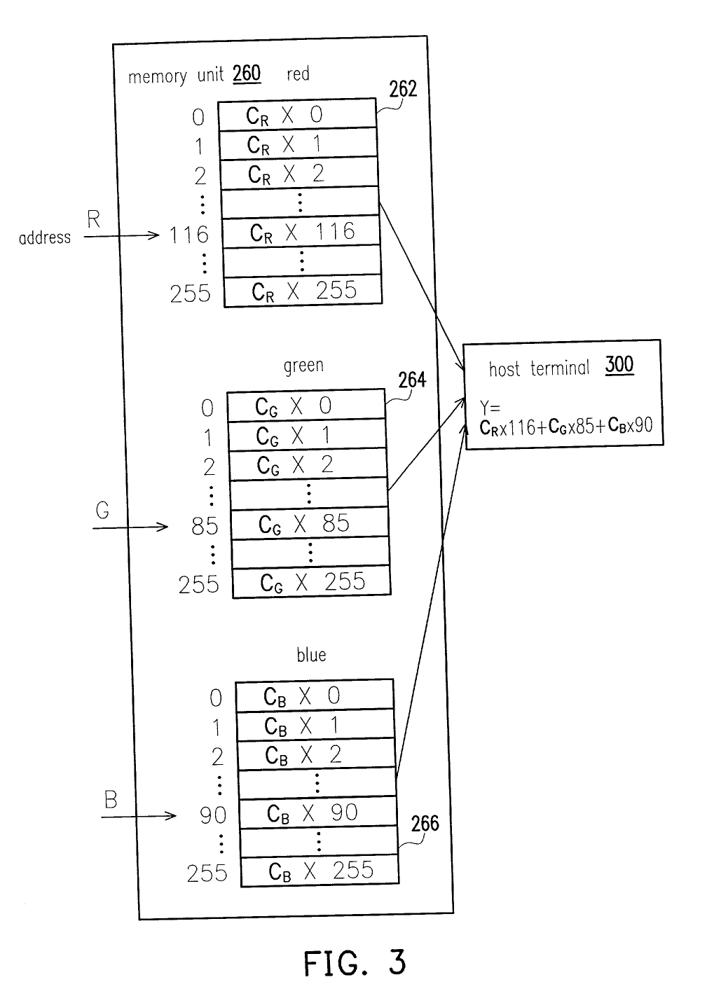

FIG. 1 is a flow chart showing a method of scanning gray scale images using a color scanner according to this invention. FIG. 2 is a block diagram showing a color scanning system for scanning a gray scale image according to this invention. FIG. 3 is a schematic diagram showing the memory structure within a color scanner according to this invention. FIGS. 1, 2 and 3 together illustrates a method and system for scanning gray scale images using a color scanner. A color scanner 200 capable of scanning gray scale images is shown in FIG. 2. In general, a gray scale image contains a plurality of gray scale pixels at various gray scale colors. Each gray scale pixel has 8 bits. In other words, a byte is used to register brightness value and strength level. On the other hand, the color scanner 200 has memory space for holding three bytes of data per pixel because the color scanner 200 needs to register the brightness value and strength level of each primary color (R, G, B). Therefore, very high-quality gray scale images may be obtained when the color scanner 200 scans a gray scale picture.

However, when the quality of gray scale image scanning is boosted, production cost of a color scanner is increased or scanning speed is reduced. The method described in this invention is directed to speeding up gray scale scanning and improving scanning quality at the same time without incurring addition hardware cost.

The method includes several steps as shown in FIG. 1. First, three groups of gamma tables are downloaded from a host terminal 300 to the memory unit 260 of the color scanner 200 in step s100. Gamma tables 262, 264 and 266 inside the memory unit 260 is shown in FIG. 3.

Each group of gamma table includes a plurality of index address and each index address corresponds to a storage space. Each storage space holds a color space conversion value related to color-to-gray scale conversion.

The color space conversion value is a value obtained by multiplying a primary color coefficient by a preset primary color brightness value. The primary color coefficients are fixed constants related to color-to-gray scale conversion. The red color has a coefficient C_{R}=0.299, the green color has a coefficient C_{G}=0.587 and the blue color has a coefficient C_{B}=0.114. The preset primary color brightness values and strength level depend on the setting inside the host terminal 300. In other words, if the internal setting of the host terminal 300 is in full color mode, each color uses 8 bits to indicate the strength level. Hence, each primary color is divided into 256 strength levels.

As shown in FIG. 3, the three gamma tables (for holding the three primary colors red, green and blue) inside the memory unit 260 indicate that the number of storage spaces inside the host terminal 300 is proportional to the preset primary color brightness value strength value. In other words, each strength level occupies a storage space. Because each index address corresponds to a storage space, if the host terminal 300 partitions the strength level of each primary color into 256 types, each gamma table has 256 index addresses and storage spaces for addressing and holding the 256 color space conversion values.

Note also that because the color scanner in a full color mode uses 24 bits to process the brightness value of the three primary colors, the 24 bits can have altogether 16,777,216 combinations of brightness value strength levels (2 to the power of 24). Compared with a one channel 8-bit gray scale image scanning, ultimate scanning quality is considerably higher.

While downloading the gamma table in step s100, the scanning of gray scale pixels in step s102 may start so that converted digital data 242 is transferred to the buffer region 240. Obviously, the buffer region 240 contains digital data other than the digital data 242. To simplify explanation, only the three digitized primary color brightness values inside a packet of digital data are shown. The digital data packet 242 includes a digitized red (R) primary color brightness value 244, digitized green (G) primary color brightness value 246 and digitized blue (B) primary color brightness value 248. Furthermore, each digitized primary color brightness value corresponds to a gamma table, the gamma table 262, the gamma table 264 and the gamma table 266, respectively.

After obtaining the three digitized primary color brightness values for red, green and blue in step s102, the control device 250 compares the three digitized primary to color brightness value obtained by scanning the gray scale pixel with the index address of corresponding three groups of gamma tables in step s104. In this embodiment, the three digitized primary color brightness values are assumed to be R:116, G:85 and B:90. The control device 250 refers to the three gamma tables and compares the scanned three digitized primary color brightness value with the index addresses in the three groups of gamma tables. When three index addresses having values identical to the three digitized primary color brightness values are found in step s106, three color space conversion values belonging to the gray scale pixels are retrieved from the storage spaces that correspond to the index addresses. In this embodiment, the color space conversion value 34.68 (0.299*116) for converting primary color red to gray scale is obtained from corresponding gamma table 262. Similarly, the color space conversion value 49.90 (0.587*85) for converting primary color green to gray scale is obtained from corresponding gamma table 264 and the color space conversion value 10.26 (0.114*90) for converting primary color blue to gray scale is obtained from corresponding gamma table 266.

After all three color space conversion values of gray scale pixels is obtained by the control device 250 in step s106, the three color space conversion values are transferred to the host terminal 200. In step s108, the host terminal 300 performs two adding operations to add together the three color space conversion values that belongs to the gray scale pixels. Ultimately, the gray scale brightness value 94.84 (that is, 34.68+49.90+10.26) related to the gray scale pixels are found.

The aforementioned three digitized primary color brightness values (116, 86 and 90) are not yet gamma-corrected brightness values. In other words, the brightness values R, G, B in the computational formula Y=C_{R}^{*}R+C_{G}^{*}G+C_{B}^{*}B. However, user may use scanning software within the host terminal 300 to modify the preset brightness values, for example, increasing or reducing the preset brightness value of the three primary colors. When a user initiates this type of modifications, the host terminal 300 may transmit modification instructions to a gamma correction circuit 230 via a driving program 302. The gamma correction circuit 230 executes a gamma correction to modify the brightness values of the three scanned digitized primary colors. In other words, brightness values of color image data after a gamma correction are R′, G′and B′ according to the computation formula Y=C_{R}^{*}R′+C_{G}^{*}C′+C_{B}^{*}B′.

As shown in FIG. 2, the gray scale image scanning system of this invention contains components that are present in most color scanners. A charge coupled device (CCD) 210 is a device for scanning gray scale images. Incoming light is detected by pixels on the CCD 210 and light intensity at each pixel is converted to an analogue signal. The analogue signal is converted to a digital signal via an analogue/digital converter 220. If a user needs to modify the preset brightness value via the host terminal 300, the converted digitized primary color brightness values may be modified through the gamma correction circuit 230. However, if user does not change the internal preset brightness valued within the host terminal 300, converted digitized primary color brightness values may be transferred to a buffer 240 for temporary storage.

The buffer 240, the control device 250 and the memory unit 260 shown in FIG. 2 are present in most color scanners. The control device 250 is actually the application specific integrated circuit (ASIC). Since the functions of these devices in conducting a gray scale scanning have already been described, detailed description of their operations is omitted here.

The adder units perform two adding operations to combine three color space conversion values belonging to the gray scale pixels. Since addition is one of the functions performed by the driving program 302 inside the host terminal 300, there is no need for extra hardware.

In conclusion, major advantages of this invention include:

1. There is no need to design new circuits or introduce new software programs to perform gray scale scanning functions.

2. There is no need to transfer all computational steps to the driving program inside the host terminal and hence there is no need to transfer image data to the host computer three times. The host terminal only needs to perform simple addition. Therefore, considerable data transfer and floating point multiplication time are saved.

3. The R, G, B channels are all used to process image data in this invention so that quality of gray scale scanning is much higher than a single channel system.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method of scanning gray scale image with a color scanner, wherein the gray scale image includes a plurality of gray scale pixels, the method comprising:
downloading three group of gamma table data from a host terminal linked to the color scanner, wherein each group of gamma tables includes a plurality of index addresses, each index address corresponds to a storage space, and each storage space holds a plurality of color space conversion values related to color-to-gray scale conversion;
scanning a plurality of gray scale pixels to obtain digital data after conversion, wherein the digital data includes three digitized primary color brightness values belonging to the gray scale pixels and each digitized primary color brightness value corresponds to a group of gamma table data;
comparing the three digitized primary color brightness value obtained by scanning the gray scale pixels and the index addresses corresponding to the three groups of gamma tables inside the color scanner;
retrieving the three color space conversion values belonging to the gray scale pixels from the storage spaces that correspond to the index addresses if the three digitized primary color brightness values obtained by gray scale scanning are identical to the digitized primary color brightness value in the index addresses;
transmitting the three color space conversion values belonging to the gray scale pixels to the host terminal; and
conducting an addition of all three color space conversion values belonging to the gray scale pixel inside the host terminal to obtain gray scale brightness values that relate to the gray scale pixels.

2. The method of claim 1, wherein each color space conversion value is obtained by multiplying a primary color coefficient by a preset primary color brightness value.

3. The method of claim 2, wherein the primary color coefficient is a fixed constant related to color-to-gray scale conversion.

4. The method of claim 2, wherein number of storage spaces inside a gamma table is related to a strength level of the preset primary color brightness value.

5. The method of claim 4, wherein each strength level occupies one storage space.

6. The method of claim 4, wherein the strength level of the preset primary color brightness value is modified according to the setting inside the host terminal.

7. The method of claim 1, wherein each index address corresponds to one storage space.

8. The method of claim 1, wherein the three digitized primary color brightness values within the digital data are gamma-corrected digitized primary color brightness values.

9. The method of claim 1, wherein the three digitized primary color brightness values within the digital data are digitized primary color brightness values without any gamma correction.

10. The method of claim 1, wherein the host terminal performs two addition operations to add all three color space conversion values.

11. A gray scale image scanning system inside a color scanner for transferring gray scale brightness values to a color scanner linked host terminal, wherein the gray scale image includes a plurality of gray scale pixels, the gray scale scanning system comprising:
a memory unit inside the color scanner for holding three groups of gamma table data downloaded from the host terminal, wherein each gamma table includes a plurality of index addresses, each index address corresponds to a storage space, and each storage space holds a plurality of color space conversion values that relates to color-to-gray scale conversion;
a buffer within the color scanner coupled to the memory unit for holding at least some of the digital data scanned from gray scale pixels, wherein the digital data contains three digitized primary color brightness values and each digitized primary color brightness value corresponds to a group of gamma tables;
a control device within the color scanner coupled to the memory unit and the buffer for comparing the three digitized primary color brightness values of the scanned gray scale pixels with corresponding index addresses of the three groups of gamma tables, retrieving the color space conversion values of scanned gray scale pixels from the storage spaces corresponding to the index addresses and transferring the color space conversion values to the host terminal; and
an adder unit inside the host terminal for performing addition of the color space conversion values of the scanned gray pixels to produce gray scale brightness values related to the gray scale pixels.

12. The system of claim 11, wherein the color scanner further includes a gamma correction circuit for conducting a gamma correction of the three digitized primary color brightness values within the digital data.

13. The system of claim 11 wherein the control device includes an applicationspecific integrated circuit.

14. The system of claim 11, wherein the adder unit includes a driving program inside the host terminal.

15. The system of claim 11, wherein each color space conversion value is formed by multiplying a primary color coefficient by a preset primary color brightness value.
